(19) United States
(12) Patent Application Publication
(10) Pub. No.: US 2006/0048223 A1
(43) Pub. Date: Mar. 2, 2006

(54) Method and system for providing tamper-resistant software

(76) Inventors: Michael Chun-To Lee, Hong Kong (CN); Frank Chi-Hung Tong, Hong Kong (CN); Francis Chi-Moon Lau, Hong Kong (CN)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/929,941

(22) Filed: Aug. 31, 2004

(51) Int. Cl. G06F 12/14; G06F 11/00; G06F 11/22; G06F 11/30; G06F 11/32; G06F 11/34; G06F 11/36; G06F 12/16; G06F 15/18; G08B 23/00

(52) U.S. Cl. 726/22

(57) ABSTRACT

A method and system for protecting only a portion of the software to be protected against tampering is described. Such a portion may be stored in a tamper-resistant physical device, with optional encryption, for downloading when needed for execution. Several layers of tamper resistance are provided without excessively impacting performance of the protected software. For instance, obfuscation is applied to the code for the service module to minimize the large expense associated with obfuscation. The invention includes embodiments that deliver critical logic, policy information and other similar information with the help of mobile agents, which may be hosted by a server in a smart card.

### FIELD OF THE INVENTION

The invention is directed to protecting software against piracy, and, in particular, designing tampering resistant software.

### BACKGROUND OF THE INVENTION

Efficient enforcement of Software Copyright Protection (SCP) and Digital Right Management (DRM) schemes is desirable to protect software implementing various functionalities. Software is very expensive to create while being very easy to steal. Software piracy is a major risk (and a major loss of revenue) for software-related companies, which translates into reduced revenues and resources for development and support of software. Therefore, adequate protection against software piracy is a pressing need.

Imparting tamper-resistance to software is important in many situations such as super-distribution, electronic commerce systems using IC card, pay television systems with decoders containing secret values for descrambling image and so on. Superdistribution refers to distribution of software or digital contents, with users being charged for each use of software rather than selling an entire software product. For successful super-distribution, the software company should properly count the use of software and prevent illegal use.

Another example of the need for tamper resistance is provided by smart cards. A smart card is typically embedded with either a microprocessor and a memory chip or just memory with non-programmable logic. The microprocessor containing smart card can add, delete, and otherwise manipulate information on the card, while a memory-chip card (for example, pre-paid phone cards) can only undertake a pre-defined operation. Notably, smart cards, unlike magnetic stripe cards, can carry all necessary functions and information on the card. Therefore, they do not require access to remote databases at the time of the transaction.

There are several categories of smart cards including Integrated Circuit (IC) cards and cards incorporating other types of hardware, all of which are evolving rapidly into new markets and applications. In some electronic cash systems using smart cards, e.g., Mondex™ system, tamper-resistant smart cards are used to keep secure information, which cards may also be used for user identification. Smart cards are, however, susceptible to attacks, such as reusing information contained therein for illegitimate ends after obtaining it for purportedly legitimate purposes since they lose control over information once it is properly accessed.

Software pirates typically copy portions of software to their computer and use it without paying anything for it. Software protection has typically been provided with ad-hoc methods. There are many techniques and types of attacks that may be employed in attacks on software integrity. In addition to the familiar man-in-the-middle and other security attacks or straightforward cracking of keys for decrypting information, some examples of interest for software packages include static and dynamic analysis. Static analysis refers to techniques designed to extract information from a static image of a computer program, i.e., the code by inspection, which is more efficient, and requires less skill and tools, than analyses performed dynamically, for instance, by tracing the execution of a program. A dynamic attack, which inspects the execution path, memory status, etc. requires more skill and tools to perform.

Recently, a more precise formulation of the software protection problem has been provided by Goldreich, O. “Towards a Theory of Software Protection and Simulation by Oblivious RAMs” at the Annual ACM Symposium on Theory of Computing in 1987, also known as STOC 87. (Goldreich). Goldreich taught that efficient software protection may be provided by protecting only a small but crucial fraction of a software product, for instance, by providing a minimal portion of software in a protected hardware unit. This is a vast improvement over providing protection to the entire software package, with its higher development costs and performance penalties due to the overhead required by implementing tamper-resistance.

Preferably, tamper-resistance ensures proper operation of software while preventing extraction of secret data or other abuse of the software. Moreover, tamper-resistance enables a software vendor to enforce his own conditions upon users. Mambo et al., in “A Tentative Approach to Constructing Tamper-Resistant Software” presented at the 1997 New Security Paradigms Workshop in Langdale, Cumbria UK (“Mambo”) expansively regard tamper-resistance as a property of information stored in a device or software making it hard to read or modify by tampering.

Wang et al., in “Software Tamper Resistance: Obstructing Static Analysis of Programs “published as Technical Report CS-2000-12”, by University of Virginia Press, 2000, (“Wang”) consider the protection of an executable program in an insecure environment such that the execution of software in an untrustworthy environment may be analyzed to determine some level of assurance that the program will execute as expected. Wang discusses the need to prevent static analysis of programs to deny knowledge of program semantics, since this is required for mounting intelligent tampering attacks or impersonation based attacks on software of interest. By intelligent tampering Wang refers to unauthorized modification of a program that allows the program to otherwise continue to function in an unaffected manner, but on corrupted state or data.

Currently, there are several proposals for providing Tamper-Resistant Software (TRS). The proposed methods suffer from many deficiencies such as expensive strategies that are easily circumvented by skilled attackers. Moreover, some of the methods often make the software difficult to use by legitimate users.

Making an instruction stream hard to decipher may be accomplished by, for instance, two operations, viz., (i) replacing operation to effect replacement of specific instructions, and (ii) shuffle operation to effect shuffling of an instruction stream. The replace operation replaces a complicated operational instruction, such as ‘jsr’ used for function call, with multiple simple instructions. The shuffle operation shuffles one or more instruction streams, making the resultant code incomprehensible to an attacker. A preferred result of replacement and shuffling is to erase the patterns of a program by, for instance, making the frequency of the use of sources, e.g., the frequency of the use of a register, more uniform.

Since it is very difficult to prevent unauthorized duplication, software, does not check itself to determine whether it is an original copy, but rather it checks whether the user, or the computer, has the right to install or execute it. This checking may be implemented as a Challenge-Response approach, for instance, as described by C. Collberg and C. Thomborson, “Watermarking, Tamper-Proofing, and Obfuscation—Tools for Software Protection, in “Transactions on Software Engineering”, p. 735-746, IEEE 2002. A familiar technique is based on the CD-Key, which is a unique code sequence that the user must input correctly before the installation or execution of software can proceed. Another approach uses a “dongle,” which is a special, yet simple and inexpensive, hardware that is sold together with the software. The dongle is usually attached to a serial port so that when the software is in use, it can periodically successfully detect the presence of the dongle.

More recently, software vendors are increasing the practice of enforcing SCP by means of on-line registration control. A user is required to authenticate himself/herself and the software in order to complete the installation procedure. This deters illegal installation and use of reverse-engineered software.

To further ensure that only the customer himself/herself can use the content, content provider can, for instance, use some encryption-based access control protocol, such as that used by the Microsoft Corporation of Redmond, Wash. in the implementation of its Windowsmedia product. In this approach, each customer has his/her own copy of content presentation software that can be identified with a unique identity comprising an encoding public key and a decryption key, which is a private key. When purchasing content, the customer presents his software's identity in the form of the public key to the content provider. By using this identity, the content provider can properly “seal” the content so that it can only be opened by the customer's own presentation software using the assigned private key. To ensure that customer will use the content properly, content provider may provide user policy information, such as usage limit (number of time it can be played) and permission for duplication (whether copies of this content can be made). These policies are normally enforced by the presentation software.

However, due to the lack-of-security in the current consumer computing environment, software that implements the above-mentioned protection methods may be attacked and disabled as described by A. Maña and E. Pimentel in “An Efficient Software Protection Scheme,” and obtained from “http://citeseer.nj.nec.com/mafia01efficient.html.”

To compromise SCP, a hacker may locate and remove the code in the software that implements the Challenge-Response logic. Similarly, DRM is susceptible to a hacker modifying the presentation software to ignore the user policy attributes resulting in unrestricted access to all contents. Alternatively, the hacker could extract the decryption private key inside the presentation software, and use it to decrypt the sealed content. The presentation software may be reverse engineered to accept the now unsealed content. Such attacks and modifications may be neither difficult nor expensive to perform, thus presenting a real risk.

The TRS technologies available include Obfuscation and Secure Execution. According to the Wang reference, obfuscation refers to making the code of a program unintelligible to hackers, while preserving its functionality. This may be accomplished by “scrambling” the logical structure of the code, such as inverting the code sequence, inserting meaningless code, and replacing single jump statements with multiple, indirect jump statements. If implemented correctly, following obfuscation, a program performs like a “virtual black-box”. It is a “black-box”, since one can use it as a processing unit without understanding the implemented logic.

This black box is “virtual” because there is no physical seal blocking the access to the program and the code may be read easily. However, reading the code is of little aid since making sense of it is very nearly impossible. As a result, an attacker cannot readily re-engineer the program, or modify it in an intelligent way without damaging it. Such obfuscation can provides an effective defense against static attacks, and to a lesser extent to dynamic attacks. Following the execution path in a dynamic attack provides valuable clues for understanding the functioning of the code.

In practice, it is not easy to obfuscate a given body of code. Providing an automatic obfuscator (i.e. integrated into the compiler) has presented significant technical hurdles and is not widely available yet. Manual obfuscation, although available. In another respect, obfuscation imposes a penalty in the form of adversely impacting the performance of the software. The Mambo reference discloses that this penalty increases as the obfuscation is made more effective.

In contrast to the above described techniques, some secure execution techniques implement a “physical black-box” to block attackers from the code and its execution altogether. The code is executed in a secure environment, such as Smart Card. Encrypted code is delivered to this environment for decryption and execution with significantly reduced likelihood of a malicious attack. To this end, typically, a portion of the code that implements some critical function of the software (called as “Critical Logic” in this invention), is encrypted. When the user executes the software and invokes the critical function, the encrypted code portion is loaded into the secure environment for decryption and execution. Later, the result will be returned to the software, and the software execution continues in the normal way. This compromise between security and performance provides security at the expense of speed of execution of the code. Since the critical functions, which would execute inside the secure environment, are very often computational intensive, the actual performance of the software is impacted significantly even with less than all of the code being so secured.

In another aspect, such Secure Execution is vulnerable to a “Black-Box Attack”. In this attack, an attacker does not try to attack the Critical Logic. Instead, the attack is in the form of modifying or re-engineering the Parent section (the portion of the software minus its Critical Logic). This malicious “Parent” invokes the Critical Logic in the ordinary way, but after obtaining the output, it deviates from the legitimate use of the output. Therefore, even if the Critical Logic were well protected, the integrity of the software as a whole could not be guaranteed. In general, such an attack particularly undermines DRM software, because often the output that the malicious Parent code “steals” from the Critical Logic, i.e. decrypted content, represents the very content that the DRM software intends to protect.

There exist several computing environments that are not entirely hostile and insecure, such as that provided by the JAVA Virtual Machine (“JVM”), for allowing execution of code with varying levels of security. However, the problems of securing code against skillful attacks continues to be a problem in such computing environments compared to secure physical devices.

In such environments, which may be provided within a rather insecure computing environment, it is possible to control execution of code of interest. For instance, applications are typically allowed to access all resources in the JVM while applets, being insecure by virtue of being accessed via the Internet, are limited to a sandbox, i.e., not allowed to access any system resources. Thus, by default, applets cannot read from or write to the file system and the like. The level of access for an application or an applet may be modulated based on a policy and successful authentication.

### SUMMARY OF THE INVENTION

A method and system for providing tamper resistance to software are described. The described method and system combine several technologies to efficiently provide tamper resistance. In a preferred embodiment, a Smart Agent Framework (SAF) architecture is described in combination with JAVA based technology for implementing a particular embodiment of the invention.

The present invention provides for obfuscation of the code for one or more centralized service modules. Such a centralized service module preferably executes in a dynamic analysis resistant computing environment, which makes tracking the execution of instructions difficult to trace.

At least one portion of the software to be protected is identified as security providing section. Preferably, proper execution of such a section is required for the software to function. One or more security providing sections may be stored in a tamper-resistant physical device for downloading when needed for execution. One or more security providing sections may be encrypted. Preferably, such security providing sections are not decrypted unless ready for execution under the control of the centralized service module, preferably authenticated as well, in the dynamic analysis resistant computing environment.

The described scheme provides several layers of tamper-resistance without excessively impacting performance of the protected software. Since obfuscation is applied to the code for centralized service module in the dynamic analysis resistant computing environment, it is a cost that is not incurred anew for each new software product to be protected against tampering. Execution of code for security providing section in the context of the executing obfuscated code for centralized service module in the dynamic analysis resistant computing environment provides tamper resistance to the security providing section code since it is not readily available for static or dynamic analysis. Encryption of the security providing section code provides additional tamper resistance, if desired. Significantly, this approach limits the performance penalty incurred by providing tamper-resistance to the software.

The invention includes embodiments that deliver critical logic, policy information and other similar information with the help of mobile agents. Such authenticated mobile agents are, preferably, but not as a requirement for practicing the invention, hosted by a server in a smart card. Authentication and generation and use of session keys allows establishment of secure links, physical or virtual, between the smart card and a centralized service module. The centralized service module is preferably hosted in a computing environment resistant to dynamic analysis resulting in resistance to static analysis as well.

The invention is further described below with the help of the following illustrative FIGS. 1-4.

### BRIEF DESCRIPTION OF THE DRAWINGS

FIG. 1 shows obfuscation of the code for a service module;

FIG. 2 illustrates division of commercial software into parent and critical logic (“CL”) portions so that the CL portion is stored in a tamper-proof hardware;

FIG. 3 illustrates the interactions between various components in a system such as the obfuscated service module, parent, tamper-proof hardware and the like for rendering software tamper-proof; and

FIG. 4 illustrates a smart card and encryption based implementation in an example embodiment of the invention.

### DETAILED DESCRIPTION OF THE INVENTION

The disclosed method and system of the invention provide tamper resistant software and hardware comprising: Obfuscation and Secure Execution techniques. In addition, in a preferred embodiment of the invention, existing technologies like Java and Smart Card are employed to provide tamper resistant software and systems. An embodiment of the invention is characterized as Critical-Logic-on-Demand (“CLOD”).

The method and system of the invention, preferably, employ computing environments resistant to dynamic attacks. The computing environment provided by JVM is an example of a suitable computing environment, being designed to securely move and execute code over a network. Runtime checks during execution of code along with a strongly typed design guard against erroneous and/or maliciously generated bytecode. Code is moved over the network as a jar file with encryption using a public-private key scheme. Thus, code signed using the private key of the signer can be run on client machines provided the public key corresponding to the signer is trusted.

For software or programs to be protected by the system and methods of the invention, a portion of the code that is important for the functioning of the software or programs is identified as the corresponding critical logic. However, additional or less code may be used as a security providing section that is protected against tampering with the aid of tampering resistant hardware such as a tamper-proof physical device. Examples of such hardware are provided by smart cards, dedicated chips, and many other devices that do not allow their contents or processes to be monitored easily.

The critical logic or, more generally, the security providing section is executed in a dynamic analysis resistant computing environment so that the execution of the security providing section cannot be tracked for dynamic analysis that would otherwise provide clues as to the structure of the security providing section code. Such dynamic analysis resistant computing environment may be implemented by software on a general purpose computer or provided in dedicated hardware such as a smart card. For instance, the JVM may be hosted by a smart card or a general purpose computer. Alternatively, the security providing section code is executed in the dynamic analysis resistant computing environment, with the code for the dynamic analysis resistant computing environment obfuscated. In addition, the security providing section code may be encrypted and even sand-boxed to provide additional levels of protection against tampering.

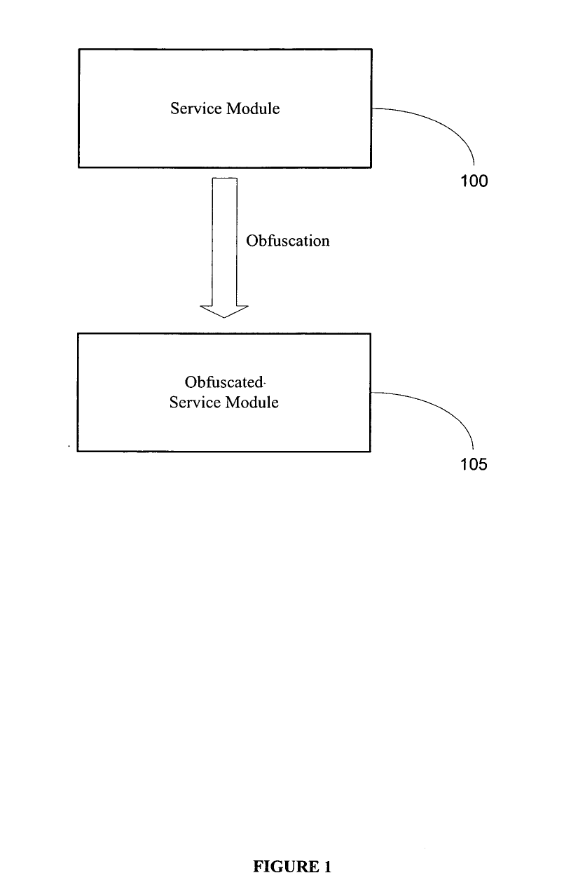

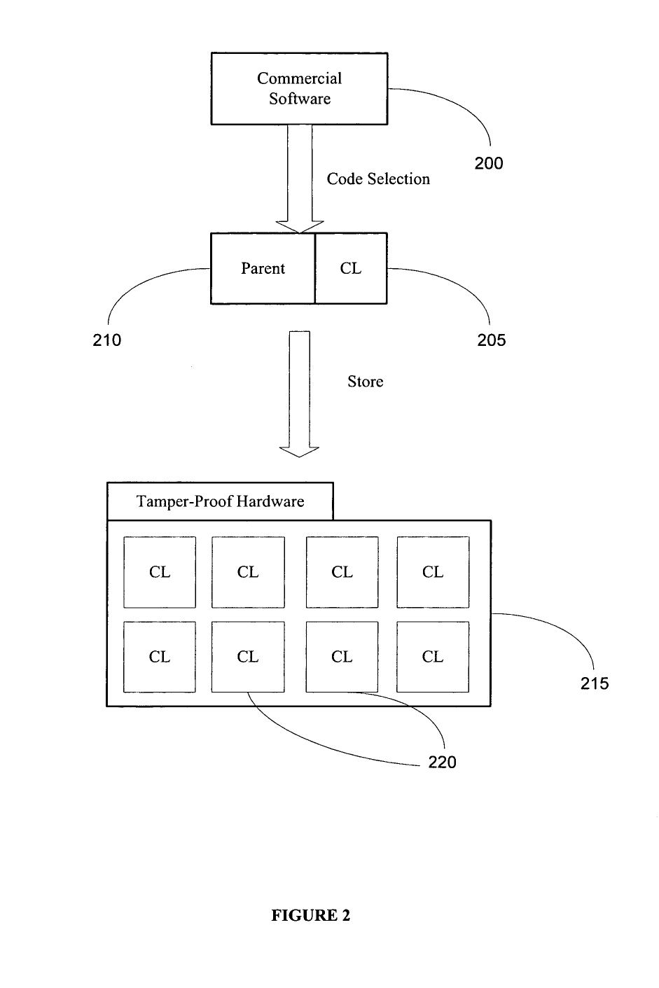

FIGS. 1-3 illustrate an illustrative embodiment of the invention. In the illustrated embodiment, FIG. 1 shows that Service Module 100 is obfuscated to generate Obfuscated Service Module 105. Since Obfuscated Service Module 105 is shared between several parents, it can be strongly obfuscated to make it into an effective black box to attackers since the expense of providing obfuscation may be shared by the various software packages that are protected with the aid of Service Module 105. In alternative embodiments, other techniques for making code impervious to inspection, including encryption and storage in secret locations may be used in combination with or in place of obfuscation. FIG. 2 shows the process of providing tamper resistance to Commercial Code 200. First, Commercial Code 200 is divided to generate Parent 205 and Critical Logic 210. Critical Logic 210 is stored in Tamper-Proof Physical Device 215. Tamper-Proof Physical Device 215 may include several Critical Logic Units 220 corresponding to different software being protected by the methods and system of the invention.

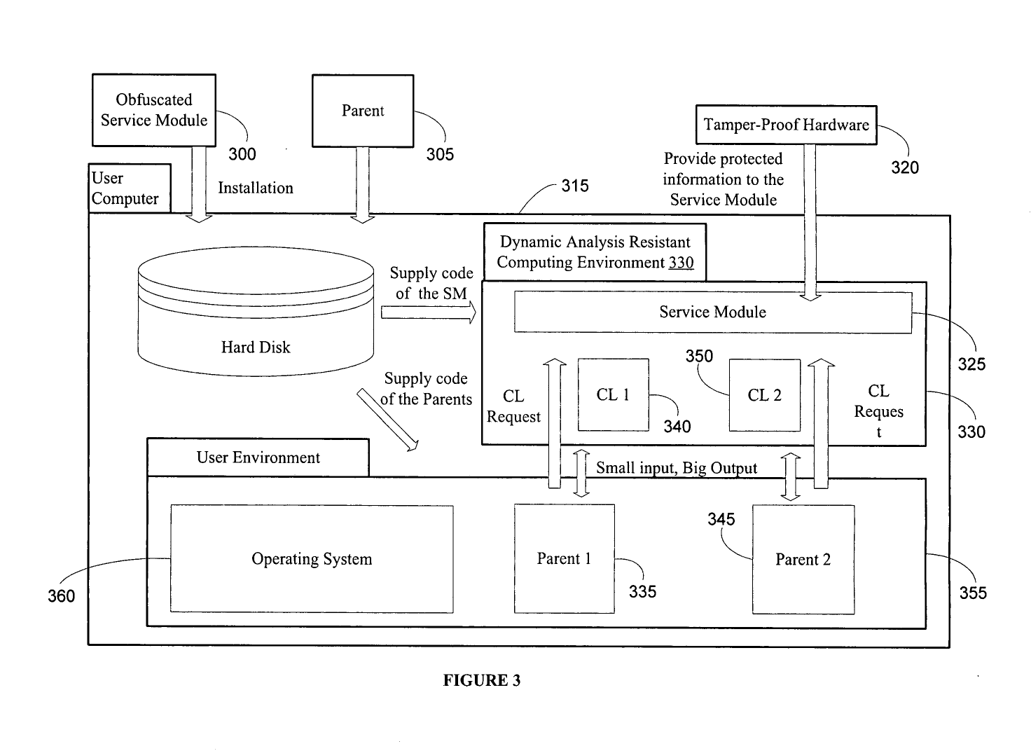

FIG. 3 shows Obfuscated Service Module 300 and Parent 305, which are installed on Hard Disk 310 of User Computer 315. Also shown is Tamper-Proof Hardware 320, which is in communication with Service Module 325 in Dynamic Analysis Resistant Computing Environment 330, such as a Java Virtual Machine, in User Computer 315. Tamper-Proof Hardware provides a stored critical logic corresponding to a particular parent in response to a request to Service Module 325. For instance, Parent 335 corresponds to Critical Logic 340 obtained by Service Module 325 from Tamper-Proof Hardware 320. Similarly, Parent 345 corresponds to Critical Logic 350, which is also obtained by Service Module 325 from Tamper-Proof Hardware 320. Other critical logic code, although not shown in FIG. 3, may be obtained from other tamper-proof hardware or even from Hard Disk 310. In embodiments alternative to the preferred embodiments, if stored on Hard Disk 310, critical logic is encrypted and may even be stored in a secret location. In alternative embodiments, critical logic may also include usage counters and be stored separately and securely to prevent blind replay. Also shown in FIG. 3 is User Environment 355 that includes Operating System 360, which assists in the execution of Parents 335 and 345.

To summarize, the method and system of the invention protect the Critical Logic Units of the protected software. This protection is provided even when the protected software is not running by making it unavailable for static analysis. The Critical Logic Units of the protected software are delivered for independent execution under control of the Service Module in response to a request, for instance, from the Parent, i.e. On-Demand. Hence, an embodiment of the invention is named Critical-Logic-On-Demand (“CLOD”)

Dividing software of interest to identify critical logic, commercial or otherwise, is well-understood. For instance, some useful criteria include (i) selecting a small code segments, preferably the smallest code segments, that are absolutely required for execution of the entire software package; and (ii) preferably, the output of a critical logic is significantly larger than its input, inter alia to discourage black box attacks.

In a preferred embodiment of the invention, the, expensive Obfuscation step is performed for the service module, such as Service Module 325, thus dividing the cost of providing obfuscation over various different commercial and other software packages that may be protected by a single service module or a small number of service modules in accordance with the method and system of the invention.

Service Module 325, which is responsible for message relay, access control, etc, is no longer a performance bottleneck even though its code has been obfuscated since it requires far less execution time. Therefore, the obfuscation does not incur significant performance penalty compared to obfuscation of critical logic and similar potentially computationally intensive code. In other words, it is preferable to obfuscate the code of Service Module 325 than that of critical logic units for various software packages. In addition, in the illustrated embodiment of FIG. 3, Critical Logic 340 and 350, which includes decryption, decompression, etc, executes in User Computer 315, albeit in the Dynamic Analysis resistant Computational Environment 330 provided by, for instance, Java Virtual Machine, instead of Tamper-Proof Hardware 320. in view of the significantly slower processing speeds in Tamper-Proof Hardware 320, such as smart cards available presently, execution in User Computer 315 significantly improves performance without sacrificing tamper-resistance.

CLOD performs well against static, dynamic and black-box attacks. Against the first type of attack, Obfuscation techniques enhance integrity of the Service Module. The tamper-resistance of a Tamper-Proof Physical Device like a Smart Card can effectively block attacks directed to deciphering the stored Critical Logic Units. Against the second type of attack, the Dynamic Analysis resistant Computational Environments such as those provided by the Java Virtual Machine provide an execution platform that protects against dynamic attacks. Against the third type of attack, the enlarged output of the Critical Logic Unit provides protection against black-box attacks.

To further demonstrate the feasibility and performance of the CLOD scheme, a framework based on CLOD has been designed and implemented. This example is based on a research being conducted jointly by the E-Business Technology Institute and the Department of Computer Science and Information Systems of The University of Hong Kong.

The framework is built in accordance with the Mobile Agent system architecture such that typically a mobile agent is launched from a server, completes its job on a client and then travels back. The traveling back may be when the parent calls for its Critical Logic. In this context, as commonly understood, Mobile agents are autonomous goal-oriented software entities that can communicate with other agents, and can continue to operate even after the machine that launched them has been removed. Mobile agents can, for instance, halt themselves, ship themselves to another agent-enabled host on the network, and continue execution. Mobile Agent: A kind of Mobile code, which would not execute in one machine only. Typically, it will be launched from a server, completes job on a client, and then travels back. Session A round trip stated at (#3). It occurs when the Parent calls for its Critical Logic

In this illustrative embodiment of the invention, a Java based development platform is used to advantageously utilize dynamic loading and execution of code, a very useful feature for building a system with Mobile Agents. Besides Critical Logic, a mobile agent in this architecture can also carry sensitive data. Such data is preferably persistent across multiple sessions, for instance, when the call from a parent causes completion of a Mobiel Agent's roundtrip. Persistent data may even be the usage limit counter of a piece of content in a DRM application. In this setup, Critical Logic is carried by a Mobile Agent and delivered on-demand to a client that has no a priori knowledge of the Critical Logic.

The Mobile Agent Server is implemented in a Smart Card to provide tamper-proof hardware that is desirable from not just security, but also from the perspective of economical hardware for such applications. One or more Smart Cards are used to manage the storage and delivery of Mobile Agents. As this example framework uses Mobile Agent and Smart Card, it is also known as the “Smart Agent Framework” (SAF), and the Mobile Agent is known as the “Smart Agent”.

Mobile Agent is not delivered to a Service Module prior to authentication. Moreover, the delivery is not one-off, i.e. the delivery is a multi-step process. This increases the difficulty of maliciously obtaining a fully-functional Mobile Agent. An example authentication protocol is built into the framework.

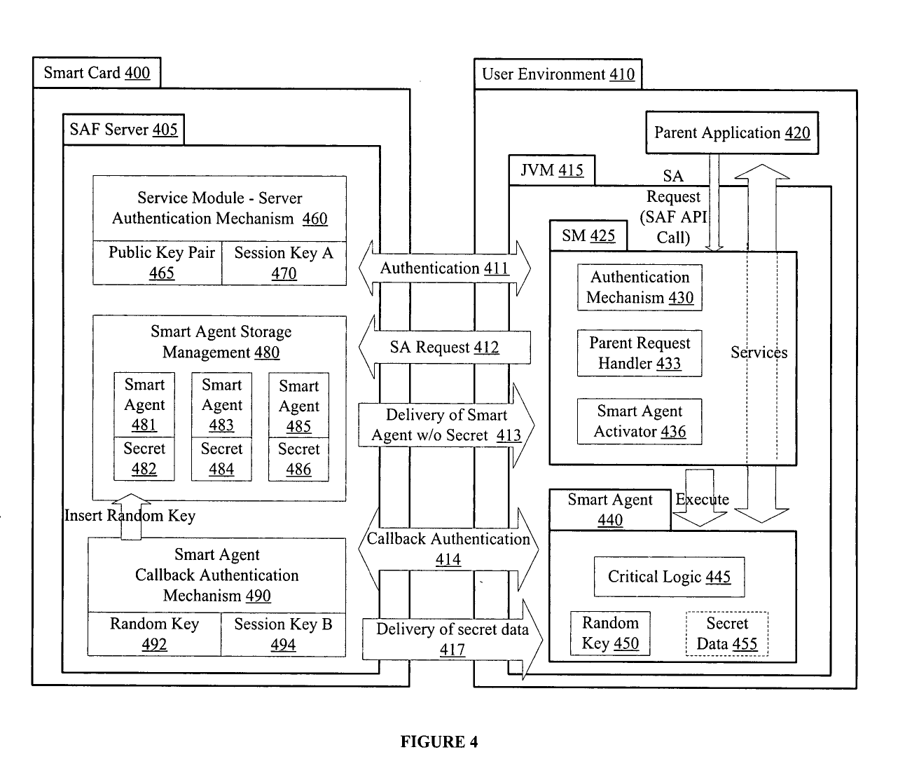

FIG. 4 illustrates the use of Mobile Agents in providing Tamper-Resistant software in accordance with the invention. FIG. 4 shows Smart Card 400 in communication with User Environment 410, which includes Parent Application 420. SAF server 405 in Smart Card 400 is initialized when the system boots up. Parent Application 420 requests the service of a Smart Agent, by contacting SAF Service Module 460, using the SAF API call. This request is routed to SAF Server 405 in the Smart Card 400.

FIG. 4 shows SAF Service Module 425 executing in JVM 415 and capable of communicating with SAF Server 405 in Smart Card 400 as well as Parent Application 420, for instance, via Parent Request Handler 433. Typically, Service Module 425 and SAF Server 405 authenticate each other, for instance, using Public Key Pair 465 in Authentication Process 411 and by Authentication Mechanism 430, with the concomitant generation of a session key (Session Key A 470). Session Key A 470 is, then, used to encrypt a Smart Agent transmitted between SAF Server 405 and Service Module 425.

Following authentication, Service Module 425 sends Smart Agent Request 412, typically to obtain Critical Logic 445 requested by or required for the execution of protected software containing parent Application 420. Several Smart Agents 481, 483 and 485 are accessible via Smart Agent Storage 480 for fulfilling request such as Smart Agent Request 412. As shown, but not as a requirement for practicing the invention, each stored Smart Agent includes secret data. For instance, Smart Agents 481, 483 and 485 correspond to Secret Data 482, 484 and 486 respectively.

In response to the Smart Agent Request 112, Random Key 492 is generated and inserted into a Smart Agent. This key is subsequently used for the callback authentication protocol, for instance, by Smart Agent Call Back Authentication Mechanism 490. Smart Agent 440 is encrypted without its secret data with Random Key 492 and delivered in transaction 413 to Service Module 425, where following receipt, it is decrypted and initialized by Smart Agent Activator 436.

In the described example embodiment, random key 450 and random key 492 are the same. Random Key 492 is generated by Smart Agent Call Back Authentication Mechanism 490 and inserted into smart agent 481 before encryption with Session Key A 470 and sent to Service Module 425. When Smart Agent 481 is activated and starts running, it performs a “callback” of Smart Agent Call Back Authentication Mechanism 490 by sending Random Key 450 (which is also Random Key 492). If the callback is successful a new Session Key 494 is generated and used to encrypt the secret data 482 to 481. which is transmitted over and becomes secret data 455. However, this detailed mechanism is not a requirement for practicing the invention and should not be interpreted as a limitation on the scope of the claimed invention.

Smart Agent 440 first authenticates itself with SAF Server 405 in Callback Authentication 414 with the concomitant generation of Session Key B 494. Session Key B 494 is, then, used to encrypt secret data 455, which is delivered in transaction 417 to Smart Agent 440 in response to the successful callback authentication of Smart Agent 440 following delivery.

Smart Agent 440 uses secret data 455 to complete its task, which includes executing Critical Logic 445 to generate the requested result for Parent Application 420. Service Module 425, then, relays the Input and Output data between Parent Application 420 and Smart Agent 440 with the aid of Parent Request Handler 433. Some possible secret data may include policy information or other data required for execution of Critical Logic 445.

Upon completing its task, Smart Agent 440 is encrypted with Session Key A 470 and transported back to SAF Server 405 in Smart Card 400. Thus, Smart Agent 440 is not available for subsequent manipulation, which provides protection against malicious attacks.

The foregoing description of the preferred embodiments of the present invention has been presented for purposes of illustration and explanation. The various cited references and documents in the preceding description are all incorporated herein by reference in their entirety for all purposes. The description is not intended to be exhaustive nor to limit the invention to the precise form disclosed. As is expected, many modifications and variations will be apparent to those skilled in the art since the embodiments were chosen and described in order to explain the principles of the invention and its practical applications, thereby enabling others skilled in the art to understand the invention. Various contemplated alternative embodiments and modifications that are suited to a particular use are within the scope of the invention. It is intended that the scope of the invention be defined by the accompanying claims and their equivalents.

1. A method of providing tamper-proofing to software of interest, the method comprising:
providing a security-providing section as part of a tamper-resistant device;
providing a centralized service module for managing one or more security-providing sections in response to a request from a parent portion of the software to be protected;
in response to the request from the parent portion, executing, independent of the parent portion, the security-providing section from the tamper-resistant physical device in a dynamic analysis resistant computing environment under the control of the centralized service module; and
exchanging input and output data with the parent via a shared interface provided by the centralized service module.

2. The method of claim 1, wherein managing of the security-providing sections includes delivery and execution of the security-providing sections.

3. The method of claim 1, further comprising making code for the centralized service module hard to decipher.

4. The method of claim 3, wherein the code for the centralized service module is obfuscated.

5. The method of claim 1, further comprising dividing the software into a parent portion and one or more security-providing sections.

6. The method of claim 5, wherein at least one security-providing section is a critical logic section such that it is required for running the software.

7. The method of claim 1, wherein the security-providing section code is designed to generate output data that is greater than input data.

8. The method of claim 1, wherein code for the security-providing section is one or more of: encrypted; inclusive of policy information; stored on a hard-disk in a form opaque to usual file access mechanisms; stored on the tamper-resistant physical device external to the system where the parent portion is executing; and stored on a smart card.

9. The method of claim 1, wherein the dynamic analysis resistant computing environment comprises one or more of a smart card, and a JAVA Virtual Machine.

10. The method of claim 9, further comprising authenticating the security-providing section prior to executing code for the security-providing section.

11. The method of claim 10, wherein secret data or a checksum provides a measure of integrity of the code for the security-providing section.

12. A system for providing tamper resistant software, the system comprising:
a tamper-resistant device for storing critical logic;
a service module having an interface for exchanging input and output data with a plurality of parents; and
a dynamic analysis resistant computing environment for executing a critical logic under control of the service module.

13. The system of claim 12, wherein the tamper resistant software comprises a parent and at least one critical logic section.

14. The system of claim 12, wherein the tamper-resistant device for storing the critical logic section is one or more of a smart card, a set of hidden memory locations on a hard-disk, and encrypted data on a hard disk.

15. A method for executing tamper proof software, the method comprising:
implementing a centralized service module with code that has been made hard to decipher;
authenticating a tamper-resistant device;
establishing a secure link between the tamper-resistant device and the centralized service module;
receiving a critical logic from the tamper-resistant device with the aid of the secure link;
executing the critical logic under the control of the centralized service module; and
providing data to a parent via an interface provided by the centralized service module.

16. The method of claim 15, further comprising executing the centralized service module in a dynamic analysis resistant computing environment.

17. The method of claim 15, further comprising receiving from the parent an indication for obtaining the critical logic.

18. The method of claim 15, further comprising returning the critical logic to the tamper resistant device.

19. The method of claim 18, further comprising destroying all copies of the critical logic under the control of the centralized service module.

20. The method of claim 15, further comprising generating at least one key for encrypting the critical logic and any additional secret information, as part of the secure link, prior to sending the critical logic or the secret information to the centralized service module.

21. The method of claim 15, wherein the critical logic is delivered via a mobile agent hosted by a server on a smart card.

22. A method of providing tamper-resistance to a software package, the method comprising:
storing at least one critical logic code in a tamper resistant device;
configuring the software package to request the at least one critical logic code for execution under the management of a centralized service module, wherein code for the centralized service module executes in a computing environment resistant to one or more of static and dynamic analysis, wherein the code for the centralized service module has been made hard to decipher; and
configuring the software package to use at least one interface for sending data for or receiving data generated from the execution of the at least one critical logic code.

23. The method of claim 22, wherein the code for the centralized service module is made hard to decipher by obfuscation.

24. The method of claim 22, wherein execution of the at least one critical logic code is required for execution of the software package.

25. The method of claim 22, wherein the at least one critical logic code is provided by a mobile agent.

26. The method of claim 22, wherein the at least one critical logic code is stored in the tamper-resistant device such as a smart card or as encrypted data on a hard disk.

27. The method of claim 26, wherein the at least one critical logic code is stored together with policy information in the tamper-resistant device, wherein the policy information is used by the centralized service module to decide whether to execute or obtain the at least one critical logic code from the tamper resistant device.

28. The method of claim 22, wherein the computing environment resistant to one or more of static and dynamic analysis for the execution of the centralized service module is a Java Virtual Machine.

29. A centralized service module for managing the execution of code, the centralized service module executing in a computing environment resistant to one or more of static and dynamic analysis and implemented by code that is hard to decipher for static analysis.

30. The centralized service module of claim 29, wherein the code for the centralized service module is obfuscated during compilation to make it hard to decipher.

31. The centralized service module of claim 29, wherein the computing environment is provided by a Java Virtual Machine.

32. A smart card designed to operate with an external dynamic analysis resistant computing environment with authentication such that obfuscated code for a centralized service module executes in the external dynamic analysis resistant computing environment and the smart card provides at least one critical logic to achieve one or more of a generation of a desired result, operation of a software application, and operation of a software module.
